(19) United States
(12) Patent Application Publication
(10) Pub. No.: US 2007/0171042 A1
(43) Pub. Date: Jul. 26, 2007

(54) Tactical surveillance and threat detection system

(76) Inventors: Petru Metes, Pittsburgh, PA (US); Abhishek Sharma, Pittsburgh, PA (US); Mark F. Desantis, Pittsburgh, PA (US); Ric A. Castro, Pittsburgh, PA (US)

Correspondence Address: THE LAW OFFICE OF RICHARD W. JAMES, 25 CHURCHILL ROAD, CHURCHILL, PA, 15235, US

(21) Appl. No.: 11/644,319

(22) Filed: Dec. 22, 2006

Related U.S. Application Data
(60) Provisional application No. 60/753,069, filed on Dec. 22, 2005.

(51) Int. Cl. G08B 19/00; G06F 19/00; G08B 1/00; G08B 1/08

(52) U.S. Cl. 340/521; 340/539.22; 340/531; 702/1

(57) ABSTRACT

A user-configurable (and re-configurable), multi-sensor system for remote monitoring and surveillance applications. A portable-reconfigurable-sensor (PRS) based monitoring platform may be able to withstand environmental, chemical, biological, or fungal attacks and may be deployed (e.g., as a projectile) using a multitude of techniques. The PRS platform may include a multitude of sensors, a computing unit, a power supply, and other circuit elements embedded in a shell or a case of a hard material so as to result in a robust structure that is rugged enough to withstand a wide range of environments. The computing unit may work with various different types of sensors depending on the desired application. Information collected by the sensors in the PRS platform may be initially processed by the on-board computing unit and then sent to a remote user for additional processing and analysis.

### REFERENCE TO RELATED APPLICATION

This application claims priority benefit of U.S. Provisional Application No. 60/753,069, filed on Dec. 22, 2005, and titled “OmniScientek Omniball”, the entire disclosure of which is incorporated herein by reference in its entirety.

### BACKGROUND

1. Field of the Disclosure

The present disclosure generally relates to remote sensing systems, and, more particularly, to a portable and re-configurable multi-sensor system to provide real-time and remote sensing or surveillance of indoor and outdoor environments in life-threatening and hazardous situations.

1. Brief Description of Related Art

Real-time, remote perception of physically inaccessible areas may be employed in life threatening and hazardous situations. Since early days of combat, there has been a constant pursuit of this capability, so as to have knowledge ahead of time about the enemy and its ambient environment. Systems and devices used in combat and for such knowledge include man/machine reconnaissance systems, spy satellites, spy planes with stealth technology, and newer reconnaissance devices like collaborative UAVs (Unmanned Aerial Vehicles). However, while these technologies may be practically feasible, they may not be pragmatic because of their lack of resolution. For example, a spy satellite may provide limited resolution images about the activity of an enemy, spy planes may provide a limited-resolution digital elevation map of the environment, and a UAV mission may provide a rough topological map of the terrain. For a soldier in the battlefield, the information provided by these methods may not be very useful in securing the internals of buildings, caves, underground bunkers, and other man-made structures.

Furthermore, current non-contact sensor systems may be bulky, non-portable, have limited capabilities for sensing multiple parameters (e.g., visual, temperature, sound, etc.), and lack autonomous data acquisition and remote transmission capabilities. This may prohibit such non-contact sensor systems from gathering real-time information that may be used to protect the safety of people responding to life threatening situations. Therefore, it may be desirable to devise a system that can gather real-time information and be employed in various ways, such as for man/machine reconnaissance for troops to fight terrorists and urban guerilla warfare, for firefighters to determine how and where to enter buildings on fire, for HAZMAT (HAZardous MATerial) teams to detect and understand hazardous leakages in industry (e.g., a chemical plant), for stealth surveillance of houses and national and other property, etc.

Systems and methods providing remote perception of the combat environment, operating both indoors and outdoors, and/or providing “on the ground” or better levels of resolution may be employed to gather more useful information. Such information may be employed for modern day warfare. Such information may also be employed in other usage domains such as in one or more of the following: (i) Homeland security agencies like TSA (Transportation Security Administration) or the FBI (Federal Bureau of Investigation)—to fight terrorist threats. More information increases the chance of success of operations and reduces the life risk for troops. (ii) The police SWAT (Special Weapons And Tactics) teams—to undertake evasive actions against the hiding places for the non-social elements. (iii) Fire departments—to rescue people from fire, building collapse, flood and other calamities. (iv) Surveillance of national property and places of mass transit such as airports, train stations, and port authorities. (v) Manufacturing industries, such as the chemical industry, where it may be hard to detect discharge of hazardous effluents. (vi) Consumers—such as for home protection against theft and other invasive agents.

The target audience space may be significant and may cover a variety of operating environments (outdoors as well as indoors). Therefore, it is desirable to devise a system that includes one or more of the following characteristics: (i) Compact and robust; (ii) re-configurable; (iii) low-power, which may elongate the operation time; (iv) capable of fusion of data from multiple sensors, providing onboard correlation and analysis of different sensor data; (v) rapid information processing; (vi) autonomous with remote transmission capability; and (vii) disposable, low cost, and can be manufactured on a large scale.

### SUMMARY

This disclosure relates to remote, real-time perception of physically inaccessible areas in highly dynamic, life threatening and hazardous situations. Effective access to this information by the user is essential for superior mission execution, potentially saving the life of the user under stressful conditions. A solution to this problem is a general purpose sensor platform that (i) is portable and light-weight, so it can be easily carried by a human user effortlessly anywhere, (ii) has multiple sensors so it can support a variety of available sensors including, for example, electro-optical (color cameras, Laser Radar (LADAR), Infrared (IR), thermal cameras), gas sensors, chemical sensors, seismic sensors, global positioning sensors (GPS), explosive sensors, etc., (iii) has built-in intelligence so that it can receive the data from multiple sensors, condition it and then perform sensor fusion on it to convert the raw sensed data into processed, user-actionable information that is indicative of the hazards present in the sensed environment. The processed information is therefore concise, requiring greatly reduced communication bandwidth, (iv) has remote communication capability so it can send the processed information remotely and securely over sufficient distance using a limited bandwidth channel to a user end device, and (v) is remotely deployable by at least one of the following methods: throwing, propelling, launching using a any form of launcher, tossing, or by dropping from a height. The user end device may be a computer, a hand-held controller, etc., or other readout device that can be carried by a person or a vehicle.

In one embodiment, the present disclosure contemplates a sensor unit comprising a housing that includes: sensing means embedded in the housing for sensing an environment; processing means embedded in the housing and operatively coupled to the sensing means to receive sensed data from the sensing means, wherein the processing means contains means to fuse data from the sensing means and to generate processed data therefrom; transmission means provided in the processing means to transmit the processed data to a remote user; and means embedded in the housing to supply power to the sensing means, the processing means, and the transmission means, and wherein the housing is configured to withstand shocks and impacts and wherein the modular sensor unit is configured to be deployed using at least one of the following methods: by throwing, by propelling, by launching using a launcher, by tossing, and by dropping from a height.

A sensor system according to an embodiment may be employed in one or more of the aforementioned ways. In an embodiment, the sensor system may address such real-life situations and may include a platform for a real-time, portable, reconfigurable non-contact sensor, which may, in an embodiment, be called the “portable-reconfigurable-sensor” (PRS). In an embodiment, the PRS may include limited bandwidth transmission capability for remote perception using data-compression and pervasive and ubiquitous computing. The sensor system may include a “PRS platform” containing a non-contact sensor assembly design that provides a framework that is compact, yet can accommodate some or most kinds of non-contact sensors.

In one embodiment, the sensor system may be general purpose and be reconfigurable by a user and may enable the user to design a sensor system based on the user's specific needs. The sensor system may, in an embodiment, “fuse” or convert sensor data into a stream of intelligent information as per the user-specified application, such as for military, public safety, or commercial use.

In an embodiment, the PRS platform includes a “stealth omni-cam” (SOC), which may include a PRS outfitted with multiple cameras and audio input. This sensor system may, in an embodiment, autonomously acquire 360° Field of View (FOV) and remotely transmit information—up to several hundred feet, for example—to a handheld/laptop computer or receiver. This embodiment may provide a complete view of a surrounding area of the environment being monitored, providing the user with tactical information that may be employed to make informed decisions on subsequent actions.

In one embodiment, the PRS platform includes a BioPRS, which may be a PRS configured for unconventional war and HAZMAT situations. The BioPRS may be outfitted with multiple sensors, such as, for example, IR cameras, acoustics sensors, thermal sensors , gas sensors (all kind of gas sensors, like for example, Carbon-dioxide sensors, Sulphur-dioxide sensors, etc), chemical sensors, explosive sensors, LADARs, radiation sensors, seismic, GPS, and optical sensors, visible band cameras, etc. This embodiment may provide first responders information about unconventional war agents like biological, chemical, radiation, or explosive attack and help develop the correct response strategy.

In various other embodiments, the PRS platform may be employed to facilitate fighting against terrorists, full scale ground combat, combat tasks by SWAT teams, or to help firefighters to save lives. The PRS platform may be outfitted with different sensors, and may include or be employed with nanotechnology and MEMS (Micro Electro Mechanical Systems) industry applications. Such systems may facilitate the development of low cost, low power, portable, and compact sensors and devices. The PRS platform, in an embodiment, may provide faster access to a greater breadth of information concerning hazardous situations, providing the key personnel with a low cost, easy to use tool that saves lives.

In a further embodiment, the present disclosure contemplates a multimedia device that is equipped with multiple cameras (e.g., color, monochrome, night vision, and thermal cameras, with fixed lenses or with zoom lenses) to provide a remote visual view of an environment and audio sensors to provide sound information. The device may be packaged in an embodiment, which can be deployed remotely by performing one or more of the following actions: throwing, tossing, dropping, or launching from a ballistic medium. The device is equipped with electronics to receive, process, and package the image stream and also perform a variety of image processing tasks(for example, object detection, tracking, and recognition) and transmit the information wirelessly to the end user. The end-user may be equipped with portable computing units such as, for example, laptop computers, handhelds, smart phones, multimedia goggles, etc. The transmitted images can be used to detect a threat or threats and can be used for monitoring, surveillance, object tracking, and other visual processing. The device may have built-in self localization capability even when deployed in indoor environments and may be able to communicate with other devices of the same kind or different kind through mesh networking protocols.

The multimedia device may have the following features: (i) Portable—the device can be embodied in a form factor of the size of a tennis ball or smaller. This form factor is not constrained by the shape and the device can be put in a multitude of forms as per the deployment method. (ii) Configurable—the device can be outfitted with multiple types of multimedia sensors, all may be of the same kind or of different kinds. (iii) Programmable—the device may be equipped with intelligent algorithms, which can control the quality of multimedia signals (e.g., through compression, distortion removal, etc.), transmission, secure encryption, digital signal processing, image processing tasks (for example, object detection, tracking, and recognition etc), and other complex mathematical processing. The device can also be programmed remotely in real-time or near real-time. (iv) Disposable—the device may be disposed after it has been damaged, or the battery power runs out. All of these features may be achieved in design by using different electronic and mechanical components.

### BRIEF DESCRIPTION OF THE DRAWINGS

For the present disclosure to be easily understood and readily practiced, the present disclosure will now be described for purposes of illustration and not limitation, in connection with the following figures, wherein:

FIG. 1 shows a high level system architecture of an exemplary PRS platform according to one embodiment of the present disclosure;

FIG. 2 illustrates an exemplary structural view of the PRS platform shown in FIG. 1;

FIG. 3 is a detailed view of an exemplary sensor system including a PRS platform according to one embodiment of the present disclosure;

FIG. 4 depicts an exemplary architecture of the embedded system shown in the PRS platform of FIG. 3;

FIG. 5 illustrates architecture of an exemplary universal sensor connector (USC) according to one embodiment of the present disclosure;

FIG. 6 illustrates an exemplary hardware design for the universal sensor connector shown in FIG. 5; and

FIG. 7 depicts a layered architecture for data fusion according to one embodiment of the present disclosure.

### DETAILED DESCRIPTION

Reference will now be made in detail to certain embodiments of the present disclosure, examples of which are illustrated in the accompanying figures. It is to be understood that the figures and descriptions of the present disclosure included herein illustrate and describe elements that are of particular relevance to the present disclosure, while eliminating, for the sake of clarity, other elements found in typical remote sensing or surveillance systems.

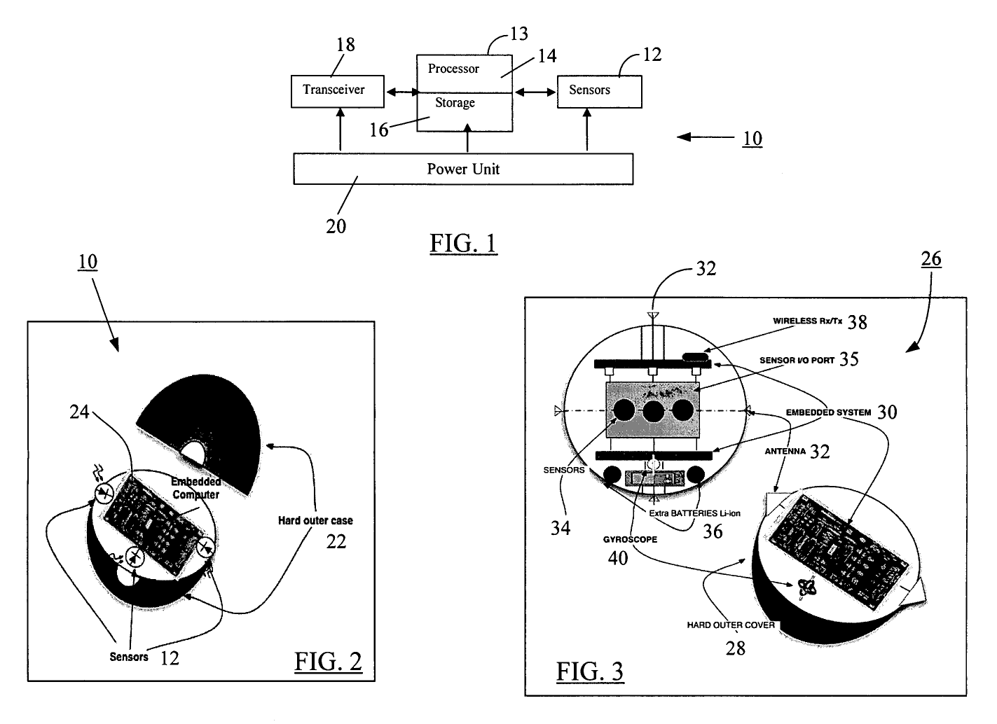

FIG. 1 shows a high level system architecture of an exemplary PRS platform 10 according to one embodiment of the present disclosure. The platform 10 may include a sensor system 12 with a plurality of sensors in electrical communication with a processing unit 13 including a processor 14 and a storage unit 16. The processing unit 13 may be in communication with a transceiver 18 to carry out data transmission/reception operations. All of the system components 12, 13, and 18 may be provided with an on-board power unit 20. In one embodiment, the system components 12, 13, 18, and 20 of the PRS platform 10 may be embedded on a single circuit board, which can be a custom-designed embedded system as small as 1.5×1.5×1.5 inches. The embedded system may have the following features according to one embodiment of the present disclosure: (i) High computing power, which can be obtained using a dual clock processor to conserve power. (ii) A math co-processor (which may be part of the processor 14) for performing complex floating point computations. (iii) Event driven power consumption architecture which would allow (a) automatic sensing from the environment using a multitude of sensors 12 (b) based on a request remotely received from a human user. (iv) Specialized DSP (Digital Signal Processor) chipset for onboard signal processing. (v) The transceiver 18 may be decoupled into a transmitter (not shown) and a receiver part (not shown). Both of the transmitter and the receiver may be powered separately and their frequency of operation may be different. Furthermore, the frequency of operation (for wireless communication through the transceiver 18) can be programmed by the user/administrator of the platform 10 using predetermined codes to avoid any potential frequency jamming in the field. (vi) Onboard memory storage 16. (vii) A specially designed Universal Sensor Connector (not shown) attached to the processor 14 using a data bus (not shown).

The multilevel architecture described above and shown with reference to FIG. 1 may be used to derive multiple threat detection capabilities. Using the architecture of FIG. 1, multiple sensor streams can be used to detect a single threat or to detect multiple threats. Algorithms employing mathematical techniques to analyze time series data (from multiple sensors) and use that data for threat refinement may be implemented for the platform 10. The algorithms may perform data fusion of data streams from multiple sensors for threat discrimination. Various such algorithms are known in the art, and, hence, additional discussion of the data processing algorithms is not provided herein for the sake of brevity.

FIG. 2 illustrates an exemplary structural view of the PRS platform 10 shown in FIG. 1. As shown in FIG. 2, the sensors 12 and other system components 13, 18, and 20 of the PRS platform 10 may be embedded within a mechanical structure 22. The sensors 12 are shown separately in FIG. 2, whereas other system components 13, 18, and 20 may be part of the embedded computer unit 24. The mechanical structure 22 may be external as well as internal so as to provide a robust and rugged PRS platform 10. In the embodiment of FIG. 2, the mechanical structure 22 may include a hard case that: (i) can take any close geometrical shape (e.g., a spherical shape shown in FIG. 2), which can withstand heavy impact and shocks.; (ii) can work in highly rugged and hostile environments; and (iii) can be designed to make the platform 10 deployable by throwing, tossing, lunching through a ballistic launcher, shooting using a gun etc. The internal mechanical assembly may protect the electronics against any external impacts and shocks. The PRS platform 10 may further include auto balancing and self orientation capability for maximum sensor coverage as discussed later with reference to FIG. 3 hereinbelow. In one embodiment, there may be embedded lenses (not shown) inside the structure 22 for optical collection of environmental data. In another embodiment, a directional antenna (not shown in FIG. 2, but depicted in FIG. 3) may be directly embedded in the outer mechanical structure 22.

The mechanical structure 22—whether internal or external to the embedded components—may be made of special materials for different operating conditions (e.g., high temperature, moisture, heat gradient, ballistic shocks, effect of external abrasive agents, etc.). Special materials may be used to build embodiments that are ballistic or embodiments that can withstand various chemicals. Similarly, special materials may be employed to allow embedding of special lenses (not shown) for the camera (not shown) in the PRS platform 10.

The PRS platform 10 may, in an embodiment, be a low power, versatile sensor assembly that is compact yet robust and is reconfigurable. In one embodiment, the PRS platform 10 may have one or more of the following attributes: (i) It may be a compact yet robust assembly design, with an overall size of the spherical outer case 22 measuring 6″ in diameter. (ii) It may be user configurable and may be flexible such that it can be outfitted with different sensors (e.g., original sensors can be removed and replaced with different sensors as per the desired application). (iii) It uses low power embedded systems that provide onboard computing capability. (iv) The variety of sensors supported by this PRS platform 10 may include: gas sensors, motion sensors, thermal sensors, acoustics sensors, sonar sensors, optical sensors, seismic sensors, inertial sensors, explosive sensors, biological sensors, chemical sensors, laser radars (LADAR) and GPS (Ground Positioning System) sensors. (v) The PRS platform 10 may use low power designs to enable the sensor system 12 (FIG. 1) to have multiple sensors on the same board and still meet the in-field requirements. (vi) Onboard computation (e.g., by the processing unit 13 in the embodiment of FIG. 1) may provide low-level information processing and data compression, which may enable remote operation. Additional and complex processing may be carried out at a remote user location based on the data received from the processing unit 13 in the field. (vii) The PRS platform 10 may also have remote perception capability (e.g., to receive commands from a remote user), which may be powered by limited bandwidth wireless transmission to a remote console. This console may be a portable computer or a hand-held device (not shown), for example. (viii) Instead of wireless data transfer, the PRS platform 10 may be configured to facilitate wired information transfer to support rugged environments such as underwater or wireless unfriendly environments.

FIG. 3 is a detailed view of an exemplary sensor system including a PRS platform 26 according to one embodiment of the present disclosure. The PRS platform 26 may include an exterior covering or outer cover 28, an embedded computing system 30, one or more antennas 32, one or more sensors 34 with a sensor I/O port 35, on-board power supply 36, wireless data transmission/reception port 38, and a positional orientation device (e.g., a gyroscope) 40. Each of these components is described in detail hereinbelow. It is noted here that the PRS platform 26 may also include a self-localization sensor (e.g., a GPS unit) (not shown) that can obtain geographic location information through a satellite communication link and send that information to the embedded computing system 30 so as to enable the computing system 30 to properly process the sensor data in view of the geographic location identified.

The exterior 28 of the PRS platform 26 may include a spherical case having two symmetric hemispherical portions (one of which is shown in FIG. 3 for ease of illustration) made of hard-reinforced polymer, composite materials, and other advance materials and which may be clamped together. The exterior cover 28 may be rugged to ensure that the sensor(s) 34 can withstand high-pressure and impacts during use in harsh operating conditions. The symmetrical hemispherical portions clasped together may provide the user with the flexibility of putting the user's own sensors in to the PRS platform 26. The various components of the PRS platform 26 may sit inside the hemispheres, and the weights of these components may be balanced in such a way that the system can attain dynamic stability, once immersed into the operating environment. In an embodiment, to achieve dynamic stability of the PRS, a gyroscope 40 or other positional orientation device may be included. The gyroscope 40 may automatically balance the system to a desired configuration, such as where the PRS 26 is impacted or otherwise deformed. To provide a soft and agile packing for the internal hardware, silicon gel in conjunction with Styrofoam may be used in the PRS 26.

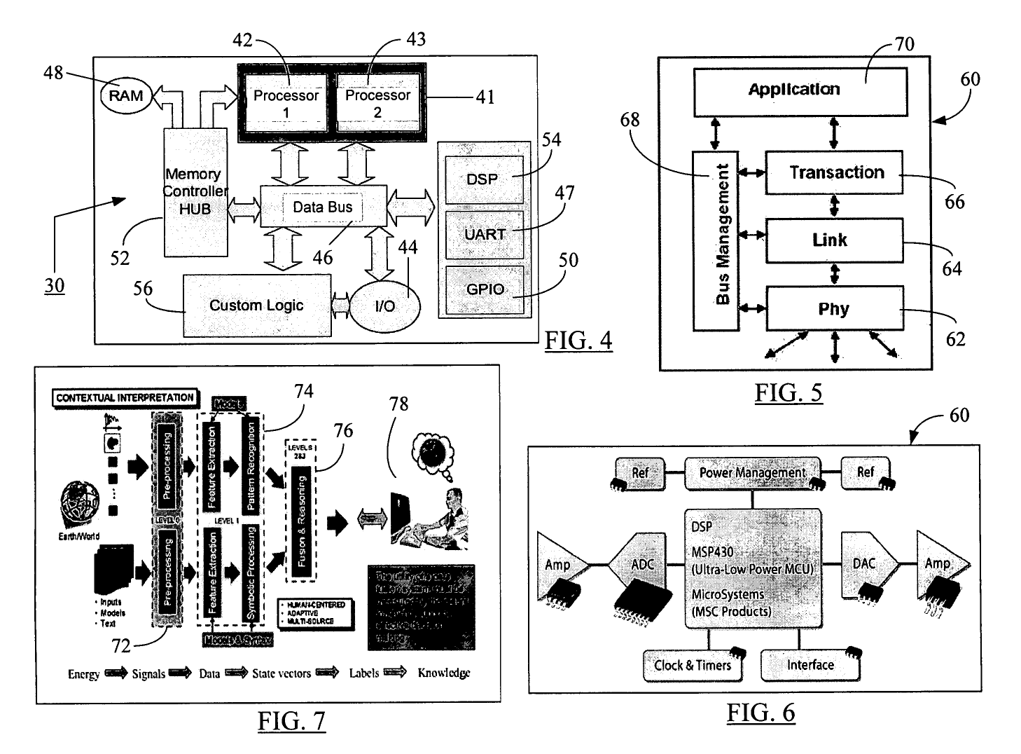

FIG. 4 depicts an exemplary architecture of the embedded system 30 shown in the PRS platform 26 of FIG. 3. The embedded system 30 may include superscalar based computer architecture as illustrated by a processor unit 41 with two processors (can be Intel® processors) 42-43 in FIG. 4. The embedded system 30 may use an asynchronous pipeline which may assign different periods of time for the execution of different instructions. By using the asymmetric pipeline, the PRS platform 26 may avoid use of a global clock and may thus reduce power consumption. The data bus may be asymmetric and may hold and transmit the data as needed for different processes as the instruction cycle is executed. A data bus and bus controller 46 may achieve the bus arbitration and avoid any resource conflict and data locking. To enhance the survival life of data, the processor 41 may be provided with a dedicated cache (not shown). An I/O port 44 of the device may support multi-channel data, and may support four different channels at the same time. The I/O port 44 may be designed so as to support both video and single channel time-series data. A universal asynchronous Rx/Tx (UART) 47 may be employed for supporting multi-speed data transfer to the global data bus 46.

In one embodiment, the processor unit 41 may be an extremely low power Intel® instruction based MPU/MCU system that balances computing power with power consumption. The following may be the detailed specifications of the embedded system 30 according to one embodiment: (i) Intel based processors 42-43 with 512 KB L2 cache and a 400-800 MHz system bus providing up to 3.2 GB/s of available bandwidth. (ii) High MIPS (Million instruction per second)—up to 430 MIPS and 1.7 GFLOPS. (iii) Up to 1MB of on-chip flash memory (not shown) and up to 32KB of on-chip RAM (not shown). (iv) Although not shown in FIG. 4, some examples of on-chip peripherals include, CAN, IrDA, USB, SCI, Smart Card, PCMCIA, SDRAM (e.g., the RAM 48 in FIG. 4), and an Ethernet connector. (v) There may be dual DDR-266 memory channels on-chip in the embedded system 30 that may operate in lock-step to provide up to 3.2 GB/s of memory bandwidth. (vi) There may also be three hub interface connections (not shown) providing multiple high-bandwidth I/O configuration options, yielding up to 3.2 GB/s of I/O bandwidth. An I/O processing unit (GPIO or General Purpose Input Output) 50 may also be provided.

A memory controller hub (MCH) 52 may be the central hub for all data passing through core system elements (single or dual processor). The MCH 52 may be to balance the bandwidth requirement for the processor 41 and the memory interfaces (Double Data Rate (DDR) SDRAM memory channels 48). The MCH 52 may have a performance of at least 2-3 GB/s of bandwidth across a 400 MHz system bus, and up to 3 GB/s of bandwidth across two SDRAMs (collectively referred to herein by the reference numeral “48” in FIG. 4). To achieve this, the MCH 52 may include one of several high-bandwidth I/O configuration options known in the art for a total of 3.2 GB/s of I/O bandwidth. The MCH 52 may thus provide balanced, high-throughput for the embedded system 30.

The processor's 41 floating-point DSP's may be designed to perform high-speed computations for real-time signal processing of the data from the attached sensors 34. The DSP (Digital Signal Processor) 54 may feature system-on-a-chip integration with on-chip memory and a variety of high-speed peripherals to provide a system 30 that has fast throughput and design flexibility (e.g., mpeg audio/video encoding, etc.). A custom logic unit 56 may be provided based on the desired application for which the PRS platform 26 is designed.

In one embodiment, the hemispheres (e.g., the hemisphere 28) are purposely designed to act as antennas, so as to avoid the use of external dedicated antennas, which may be susceptible to damage in rugged operations. The antennas 32 may be embedded in the external core 28. The two hemispheres (only one of which 28 is shown in FIG. 3 for ease of illustration as noted hereinbefore) may be divided in four symmetrical parts to emit signals, which may be 90° out of phase of each other. This orthogonal out of phase operation may provide a complete 360° surround coverage. The surround coverage may be designed to avoid the use of line of sight communication for the receiver (e.g., a remote user's laptop computer (not shown)).

In an embodiment, an input port (not shown) that can receive both 1-D and multi-dimensional signals may be employed. Such an input port may provide a configurable sensor port, which may support disparate sensors. To enable this feature, a dedicated port may be used in the PRS platform 26 of FIG. 3 and may be called a Universal Sensor Connector (USC), which may provide high speed and hot-swap ability between the sensors 34 and the PRS platform 26. FIG. 5 illustrates architecture of an exemplary universal sensor connector (USC) 60 according to one embodiment of the present disclosure. The USC 60 may use the following three layers to provide a general interface for the system (e.g., the embedded system 30 in FIG. 3) to connect to any sensor 34. (i) A Physical Layer (PHY) 62 may be responsible for the actual transmission of data over the data bus (e.g., the data bus 46 in FIG. 4). This layer 62 may also handle the bus arbitration process, which may be the request to use the bus. Whenever the bus is reset or the topology of the embedded system 30 changes, the physical layers of all devices (sensors as well other non-sensor devices) may communicate with each other to agree on a new structure. (ii) A Link Layer 64 may take the register information obtained from a Transaction Layer 66 and form the information/data packets that may be sent over the data bus. The Link layer 64 may be responsible for generating the clock signal for the whole system. There may be different levels of capabilities that a particular sensor connector may possess. The sensor connector may be alternatively referred to as a “node.” These capabilities may all be implemented on the link layer 64. A sensor may be capable of one or more of the following: (a) Transaction capable. Every node may have the capability to communicate with the data bus. (b) Isochronous capable. In order to support isochronous data transfers, the nodes or sensor connectors may have a separate clock on their link layer that enables them to detect the next instance of time for an isochronous transfer. (c) Cycle-Master capable. Cycle-Master capable nodes may be able to provide the clock that is used to control isochronous channels. (d) Bus-Master capable. Bus-Master capable nodes may be responsible for the setup of the bus topology, i.e., they may receive the ID packets of all connected sensor devices and determine the best possible virtual tree structure. (iii) The Transaction Layer 66 may be used to connect a sensor device to a parallel bus, like the Universal Transaction Serial Bus (UTSB). The transaction layer 66 may incorporate the device's registers and memory, complying with the Communications Standard Review (CSR) standard. In various embodiments, this layer may be integrated on the Link Layer 64 part of the board.

In the embodiment of FIG. 5, all of the three layers 62, 64, and 66 are shown in communication with a bus management unit 68. Furthermore, the transaction layer 66 may be in communication with an application unit 70 (which may be implemented in software) for carrying out a specific sensing application selected by a user. While the first two layers—the physical layer 62 and the link layer 64—may be implemented in hardware, the transaction layer 66 may be implemented partially both in hardware and in software.

FIG. 6 illustrates an exemplary hardware design for the universal sensor connector 60 shown in FIG. 5. Various circuit components shown in FIG. 6 are easily understood by one skilled in the art, and, hence, additional discussion of the circuit block layout of FIG. 6 is not provided herein for the sake of brevity.

Referring again to FIG. 3, it is noted that the PRS platform 26 may employ one or more lithium-ion (Li-Ion) batteries 36 as an on-board power supply to various system components. The Li-Ion batteries 36 may offer the highest energy density of all electrically rechargeable battery chemistries. The batteries 36 may measure around 50 mm by 40 mm by 5 mm and offer current capacities of 900 to 1200 mAh. Furthermore, expected incremental improvements to Li-Ion technology may lead to a 30% augmentation of battery capacity. Maximum power that can be supplied by actual source may be around 10 Ampere-hours at 12 Volts

In an embodiment, the PRS platform 26 may provide a multi-sensor platform capable of being outfitted with different sensors (without requiring a change or modification in other system components, e.g., the embedded system 30) to provide information of the environment remotely. The PRS platform 26 may thus be reconfigurable. Different individual sensor systems—based on the sensors selected for a specific application—may be derived out of a common PRS platform and may be called the vectors of the PRS platform.

In one embodiment of the PRS platform 26, to provide multiple sensor fusion, the layered data fusion architecture illustrated in FIG. 7 may be employed. The layer-by-layer features and functionality of the data fusion system and method illustrated in FIG. 7 may be the following: (i) Level-0 (indicated by reference numeral “72” in FIG. 7) may provide for association of data from object being sensed and estimation as well as pixel/signal level association from the object and characterization. This layer may provide algorithms to preprocess inputs from disparate sensors. (ii) Level-1 (indicated by reference numeral “74” in FIG. 7) may provide for object refinement such as, for example, object-to-track association, continuous state-estimation (e.g., kinematics) and discrete state estimation. This functionality may be achieved by implementation of specially tuned software or hardware filters, for example, Kalman filter, Particle Filters and their variants. (iii) Level-2 (levels 2 and 3 are collectively referenced by the reference numeral “76” in FIG. 7) may provide for situation refinement such as, for example, object clustering and relational analysis so as to include force structure and cross force relations, communications, physical context, etc. This functionality may be implemented by using clustering techniques like K-Means, N-Cut, Principal Component Analysis and techniques thereof. (iv) Level-3 (also indicated by reference numeral “76”) may provide for significance estimation (or threat refinement), which may include threat intent estimation, event prediction, consequence prediction, susceptibility and vulnerability assessment, etc. This functionality may be implemented by using various classification techniques, for example, Bayes classifiers, and other graphical model techniques. (v) At Level-4 (indicated by reference numeral “78” in FIG. 7), a user or operator may carry out process refinement using adaptive search and processing of information received through processing at levels 0 through 3. This multi-level approach may provide a robust multi-sensor fusion, and a reduced order state vector for representing the information, thus providing support for low-bandwidth of transmission.

Various capabilities of a PRS platform according to the teachings of the present disclosure are discussed hereinbelow with reference to two exemplary vector embodiments. Additional such applications of the PRS or the PRS platform may be devised as desired.

The first embodiment is referred to as a Stealth Omni-Cam (SOC), in which a PRS is embedded with multiple cameras (not shown) with audio input. This embodiment may have the camera lenses embedded on its surface. These lenses may be fixed focal length or variable length. This sensor system (not shown) can autonomously acquire omni-directional Field of View (FOV) and transmit remotely up to the order of several hundreds of feet. The receiving end of the device, being a portable computer, may provide the soldier/policeman information about the combat environment beforehand. Cameras (visible, IR, and/or thermal imager, fixed focal length or variable zoom lenses etc.) may be high-resolution sensors, which may be capable of producing close-to-human-eye perception. The advancement in digital imagery has provided camera devices that can handle almost any kind of climate condition. The cameras may operate in hostile environments and produce images which, when used in conjunction with human intelligence, may provide a rich source of information. However, a single camera may capture only a limited field of view (FOV). Thus, such a camera may not capture a full surround view. This issue has been studied with respect to omnivision in computer vision and image processing. Several systems using both hardware and software have been proposed to address this issue. These systems may not capture a wide enough view for certain applications, and may not provide panoramic imaging as may be specified or required by the US Department of Defense (DOD) (the Army, the Navy, DARPA, SOCOM, OSD and others). However, it may be desirable to have these systems with the following specifications: (i) A cheap, pervasive vision sensor, which can provide an unrestricted view of hostile battlefields. (ii) A robust and compact design, and can operate at video rate. (iii) A strong capability of working in the telepresense mode. These specifications or requirements may be met by a PRS platform (not shown) according to an embodiment of the present disclosure. The PRS platform may meet these specifications or requirements, and may provide remote omnidirectional imaging by including a PRS outfitted with multiple cameras (such as four, for example) and having the capability to transmit images through a wireless channel using compression technology. The SOC may be a real-time system that generates omnidirectional video (at 30 Hz, for example) for highly dynamic scenes (e.g., a combat environment) recorded by the multiple cameras. The omnidirectional images obtained from this SOC may be processed on-board or remotely on the receiver end. This processing may be used for object detection, recognition, tracking and other surveillance tasks.

The second embodiment may be referred to as BioPRS, i.e., a PRS for unconventional warfare. In one embodiment, such BioPRS may be a generic version of the PRS platform and may be outfitted with sensors such as IR cameras, acoustics sensors, thermal sensors , gas sensors (all kind of gas sensors like, for example, Carbon-dioxide sensors, Sulphur-dioxide sensors, etc), chemical sensors, explosive sensors, LADARs, radiation sensors, seismic, GPS, and optical sensors, visible band cameras, etc. The BioPRS may be geared towards the needs of a number of governmental agencies, such as, for example, the Department of Homeland security, SWAT, fire departments, law enforcement, etc. The BioPRS may be used by commercial users such as, for example, in chemical plants, warehouses, etc. The need for remote information gathering may pose a multitude of challenges. A generic sensor that can work dexterously in a variety of environments may be summarized, for example, as follows: (i) Mobile, compact, long-endurance, rigid and disposable design; (ii) remote operation over low-bandwidth tactical radio links; (iii) supports a multitude of sensors; (iv) provides a definitive information to the lower-end user about the environment being monitored or sensed; and (v) easy and intuitive user-interface to expedite the decision making of the lower end user. The BioPRS may meet all of the above specifications or requirements. To meet the technical challenge of fusion of data from multiple sensors, the architecture shown in FIG. 7 may be employed.

The discussion below provides information about potential applications of the PRS and PRS platforms configured according to the teachings of the present disclosure. In military applications, the DOD and its various agencies may employ embodiments of the SOC. Such a pervasive perception sensor system may be employed in military, homeland security, and civil applications. Within the realm of military, such a sensor used in remote mode may be exploited to probe particularly hostile urban or mountainous terrain for mapping or reconnaissance, or to aid in the clearing of building interiors, tunnels, and sewers. Application of the SOC technology in land operations may increase mission performance, combat effectiveness, and personnel safety, and may do so by providing, for example, one or more of the following: detection, neutralization, and breaching of enemy posts and other obstacles; EOD; physical security; logistics; urban warfare; weapons employment; and operations in contaminated and other denied areas. In the wake of an urban warfare situation, the SOC may aid in machine/man reconnaissance missions to glean invaluable information from inaccessible enemy zones and even acts as a first responder for assessing human (or otherwise) causalities and attempts to save lives. The SOC may be employed for security applications on land and in the air. In the latter instance, for example, UAV missions equipped with SOC may provide information about the environment in an unrestricted manner.

In case of public safety, the first responders may have a wide range of needs for real time information in hazardous situations. For example, these needs may include one or more of the following: (i) Fire and police (including SWAT), Homeland security—In a typical fire or life-threatening combat situation, remote information about the environment can be indispensable. Firefighters equipped with a BioPRS outfitted with sensors like thermal, IR, sonar, and acoustic sensors, may get all the information needed by them to make timely decisions before going into a building. A SWAT team, equipped with an SOC and a BioPRS, may localize their target and take suitable action based on that information. (ii) Urban Search and Rescue—Debris of collapsed multistoried buildings may pose intractable search operations. Tactical lightweight hyper-redundant robots may be used in the future for urban search and rescue missions. Such a mobile robot outfitted with a BioPRS may provide critical information, which may enhance the resolution of the information available from such missions. (iii) Hazardous situation, environment monitoring—A remote sensing or surveillance platform BioPRS may perform high-resolution, high-continuity observation/surveillance of emergency situations that may not be performed with a single device or a small constellation thereof, which may be too costly to use with airborne systems alone. A remote sensing or surveillance platform BioPRS may be capable of rapid deployment, may be used under hazardous conditions, may support other services of value to emergency management, and may offer a greater degree of control of the asset by the emergency management organization than may be offered by other systems.

In various embodiments, a PRS platform as per the teachings of the present disclosure may perform one or more of the following operations: (i) Predictive Maintenance—Vibration monitoring, oil analysis and other forms of predictive maintenance, and remote sensing using a multitude of sensors may spare facilities from minor periods of downtime, and may reduce or eliminate catastrophic equipment failure. With PRS, this predictive maintenance concept can be applied to monitor utilities (like gas, water, and electrical), manufacturing plants, refinery, and construction. (ii) Commercial Surveillance—BioPRS may be configured both in hardware and software, so as to be used for remote sensing/surveillance of public and private property. The BioPRS platform may be agile enough to be used as an active sensing device, such as for homes and port authorities, as well as for passive sensing to collect information about slow natural phenomena like wild habitat sensing, and other environmental processes.

In one embodiment, a PRS platform according to the teachings of the present disclosure may be mesh network capable in the sense that it has capability to be configured in the form a mesh network (not shown) to cover a large area. The mesh network can be deployed by a multitude of methods like deployment by a human, manned or unmanned mobile ground vehicles, manned or unmanned aerial vehicles, etc. The mesh network of sensors may become operational in real-time so as to allow the real-time threat detection for a large area in a very short time. The mesh network can also support other allied sensors, providing ubiquitous sensing. This mesh network can be build by using commercial networking protocols like Zigbee. The mesh network may have self localization capabilities and may be reconfigurable in case of a failure of one of the sensor nodes.

In another embodiment, a sensor system including a PRS platform according to the teachings of the present disclosure may be location-aware even for indoor applications. Various deployment methods may be used to deploy the PRS platform. Such deployment methods include, for example, tossing, throwing, rolling, or dropping by humans or by using unmanned systems (e.g., ground vehicles, aerial vehicles, robotic devices, etc.). The PRS platform can even be attached to the human body depending on the desired application. As discussed hereinbefore with reference to FIG. 3, the PRS platform may be equipped with specially designed directional antennas, which may be embedded in the material or outer case of the PRS platform. Furthermore, as discussed before, the information from a PRS device according to the present disclosure can be transmitted to the end user using a wireless or wired interface. For additional protection, the communication medium/channel may be made secure and encrypted, and may also be configured to handle jamming attacks (e.g., from an enemy territory in a combat environment).

A PRS platform/device according to an embodiment of the present disclosure can work in the real-time information collection mode. The PRS platform can also work in a monitoring mode, in which case the device may be left behind in the environment being monitored and can work intermittently using a sleep-wake mechanism and can only send pertinent data to the user remotely and intermittently.

In one application, a PRS platform/device according to the present disclosure may be able to detect humans in closed environment (e.g., in a cave or inside a collapsed building). The device may thus help the first responders see inside the structure under surveillance, and may also be used to monitor abandoned areas, general surveillance applications, or for periphery security. Additional and various other applications may be easily conceived based on the discussion presented hereinabove.

The foregoing describes a user-configurable (and re-configurable), multi-sensor system for remote monitoring and surveillance applications. A portable-reconfigurable-sensor (PRS) based monitoring platform may be able to withstand environmental, chemical, biological, or fungal attacks and may be deployed (e.g., as a projectile) using a multitude of techniques. The PRS platform may include a multitude of solid-state sensors, a computing unit, a power supply, and other circuit elements embedded in a shell or a case of a hard material so as to result in a robust structure that is rugged enough to withstand a wide range of environments. Information collected by the sensors in the PRS platform may be initially processed by the on-board computing unit and then sent to a remote user for additional processing and analysis.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalent.

What is claimed is:

1. A sensor unit comprising a housing that includes:
a first plurality of sensors embedded in said housing;
a computer system embedded in said housing and operatively coupled to said first plurality of sensors to receive sensed data from said first plurality of sensors, wherein said embedded computer system contains a software to fuse data from said first plurality of sensors and to generate processed data therefrom;
a transmitter unit in said embedded computer system to transmit said processed data to a remote user; and
a power source embedded in said housing to supply power to said first plurality of sensors, said embedded computer system, and said transmitter unit,
and wherein said housing is configured to withstand shocks and impacts and wherein said sensor unit is configured to be deployed using at least one of the following methods: by throwing, by propelling, by launching using a launcher, by tossing, and by dropping from a height.

2. The sensor unit of claim 1, wherein said first plurality of sensors in said sensor array is configured to be replaced by a second plurality of sensors without requiring corresponding replacement of said embedded computer system.

3. The sensor unit of claim 1, wherein said housing is configured to withstand environmental, chemical, biological, and fungal attacks.

4. The sensor unit of claim 1, wherein said first set of solid-state sensors includes at least one or more of the following sensors: acoustic sensors; explosive detection sensors;
chemical sensors; biological agent sensors; nuclear agent sensors; thermal sensors; gas sensors; motion detection sensors; sonar sensors; seismic sensors; inertial sensors; optical sensors; and GPS.

5. The sensor unit of claim 1, wherein said transmitter unit includes a receiver to receive commands from said remote user.

6. The sensor unit of claim 5, wherein said transmitter unit is configured to communicate with said remote user in at least one of the following ways: wireless communication, and wired communication.

7. The sensor unit of claim 6, wherein said housing further comprises:
multiple independent antennas embedded in said housing and coupled to said transmitter unit to facilitate data communication between said transmitter unit and said remote user;
wherein said embedded computer system is configured to select one or more of said antennas as best suitable antennas for said data communication.

8. The sensor unit of claim 1, wherein said housing is in a closed form shape.

9. The sensor unit of claim 8, wherein said closed form shape is spherical.

10. The sensor unit of claim 1, wherein said software in said embedded computer system is configured to send predetermined threat alarms to said remote user in real-time through said transmitter unit.

11. The sensor unit of claim 1, further comprising a positional orientation device embedded in said housing to maintain proper orientation of said housing when deployed in a field.

12. The sensor unit of claim 11, wherein said positional orientation device is a gyroscope.

13. The sensor unit of claim 1, further comprising a self-localization sensor contained in said housing and coupled to said embedded computer system to enable said computer system to obtain geographical location information of said housing when said housing is deployed in a field.

14. The sensor unit of claim 13, wherein said self-localization sensor is in communication with a geo-stationary satellite and is configured to operate in both outdoor and indoor environments.

15. The sensor unit of claim 1, wherein said launcher is one of the following: a hydraulic launcher, and a ballistic launcher.

16. The sensor unit of claim 1, further comprising a sensor port embedded in said housing and coupled to said computer system, wherein said sensor port is configured to support said first plurality of sensors and facilitate data transmission from said first plurality of sensors to said computer system.

17. The sensor unit of claim 1, further comprising:
a plurality of cameras embedded inside said housing and operatively coupled to said embedded computer system;
a plurality of lenses embedded in said housing and corresponding to said plurality of cameras; and
an imaging software in said embedded computer system for collecting surround-view images using said plurality of cameras and said plurality of lenses.

18. The sensor unit of claim 17, wherein said plurality of cameras is selected from the group consisting of: color cameras, black-and-white cameras, thermal cameras, IR illuminated cameras that are activated when an ambient light is under a predetermined threshold, and see-through smoke cameras.

19. The sensor unit of claim 17, wherein a number of cameras in said plurality of cameras is at least six, and wherein said images are one or more of the following: still images, and videos having a pre-selected, variable video rate.

20. A sensor unit comprising a housing that includes:
sensing means embedded in said housing for sensing an environment;
processing means embedded in said housing and operatively coupled to said sensing means to receive sensed data from said sensing means, wherein said processing means contains means to fuse data from said sensing means and to generate processed data therefrom;
transmission means provided in said processing means to transmit said processed data to a remote user; and
means embedded in said housing to supply power to said sensing means, said processing means, and said transmission means,
and wherein said housing is configured to withstand shocks and impacts and wherein said modular sensor unit is configured to be deployed using at least one of the following methods: by throwing, by propelling, by launching using a launcher, by tossing, and by dropping from a height.
